(19) United States
(12) Patent Application Publication
(10) Pub. No.: US 2026/0176176 A1
(43) Pub. Date: Jun. 25, 2026

(54) MINERALIZATION WATERWAY SYSTEM AND MINERALIZATION WATER PURIFIER

(71) Applicant: Guangdong Lizi Technology Co., Ltd., Foshan (CN)

(72) Inventors: Lin Shi, Foshan (CN); Xing Zhan, Foshan (CN); Wenbin Chen, Foshan (CN); Jiawei Chen, Foshan (CN); Yutai Huang, Foshan (CN); Guoxiang Chen, Foshan (CN); Yijie Hao, Foshan (CN); Jianbo Huang, Foshan (CN); Wei Luo, Foshan (CN)

(21) Appl. No.: 19/023,792

(22) Filed: Jan. 16, 2025

(30) Foreign Application Priority Data
Dec. 19, 2024 (CN) 202411884161.1

(51) Int. Cl. C02F 1/68; C02F 1/44

(52) U.S. Cl. CPC C02F 1/68; C02F 1/441

(57) ABSTRACT

The present disclosure provides a mineralization waterway system and a mineralization water purifier. The mineralization waterway system includes a water inlet pipeline, a pre-filter element unit, a reverse osmosis (RO) filter element unit, a mineralization filter element unit, and a water pump, which constitute a mineralization water circuit. The water inlet pipeline is connected to the pre-filter element unit, the mineralization water circuit is connected to a water inlet side of the RO filter element unit through the pre-filter element unit, to a purified water side of the RO filter element unit through the mineralization filter element unit, and to a water inlet side of the pre-filter element unit through the mineralization filter element unit; the water pump is installed between the pre-filter element unit and the RO filter element unit; and the mineralization water circuit is provided with a mineralization water circuit control valve.

### CROSS REFERENCE TO RELATED APPLICATIONS

The present application claims the benefit of Chinese Patent Application No. 202411884161.1 filed on Dec. 19, 2024, the contents of which are incorporated herein by reference in their entirety.

### TECHNICAL FIELD

The present disclosure relates to the technical field of water purification, and particularly to a mineralization waterway system and a mineralization water purifier.

### BACKGROUND

A mineralization water purifier is a type of water purification equipment that can deeply purify tap water and add mineral elements needed by human body, thereby enhancing water quality to achieve standards comparable to mineral water. By incorporating filter materials rich in minerals, the mineralization water purifier re-infuses minerals such as calcium, magnesium, iron, zinc, and other minerals needed by the human body into water. These minerals exist in an ionic state, and are more easily absorbed by the human body.

However, during normal operation of a reverse osmosis water purifier, water molecules penetrate through a membrane into a purified water side under an external pressure, while salt ions and other impurities remain on a concentrated water side. Therefore, total dissolved solids (TDS) in the water can be maintained within a normal range. Nevertheless, when the reverse osmosis water purifier stops working, the TDS can penetrate the membrane through forward osmosis, causing the TDS level to exceed the normal range. Consequently, whenever the reverse osmosis water purifier stops working for a period of time and then resumes water production, the TDS level of a first glass of water generated can be relatively high.

### SUMMARY

In view of this, the embodiment of the present disclosure provides a mineralization waterway system and a mineralization water purifier, which can achieve an effect of buffering and provide sufficient mixed water during reflux flushing, enabling a more thorough flushing of a filter membrane of a reverse osmosis filter element unit, thereby reducing TDS (Total Dissolved Solids) values and addressing a problem of high TDS values during short and frequent water drawings.

A first aspect of the present disclosure provides a mineralization waterway system, including:
a water inlet pipeline;
a pre-filter element unit, a reverse osmosis (RO) filter element unit, a mineralization filter element unit, and a water pump;
wherein the pre-filter element unit, the water pump, a purified water side of the reverse osmosis filter element unit, and the mineralization filter element unit constitute a mineralization water circuit;
the water inlet pipeline is connected to the pre-filter element unit, the mineralization water circuit is connected to a water inlet side of the reverse osmosis filter element unit through the pre-filter element unit, to a purified water side of the reverse osmosis filter element unit through the mineralization filter element unit, and to a water inlet side of the pre-filter element unit through the mineralization filter element unit; the water pump is installed between a water outlet side of the pre-filter element unit and the water inlet side of the reverse osmosis filter element unit; and the mineralization water circuit is provided with a mineralization water circuit control valve.

Optionally, wherein the mineralization water circuit includes a first mineralization water branch and a second mineralization water branch, the first mineralization water branch is connected to the mineralization filter element unit, the second mineralization water branch is respectively connected to the first mineralization water branch, the mineralization filter element unit, the water inlet pipeline, and the pre-filter element unit.

Optionally, wherein the first mineralization water branch is provided with a first one-way valve and a first switch valve, a water inlet side of the first one-way valve is connected to the mineralization filter element unit, a water outlet side of the first one-way valve is connected to a water inlet side of the first switching valve.

Optionally, wherein the second mineralization water branch is provided with a second one-way valve and a second switch valve, a water inlet side of the second switching valve is connected to both the water inlet side of the first one-way valve in the first mineralization water branch and the mineralization filter element unit; a water inlet side of the second one-way valve is connected to a water outlet side of the second switching valve, and a water outlet side of the second one-way valve is connected to the pre-filter element unit.

Optionally, the mineralization waterway system 1 further comprising: a first water quality testing instrument, wherein the first water quality testing instrument is configured to test a first water quality parameter of an upstream of the mineralization filter element unit.

Optionally, the mineralization waterway system 1 further comprising: a second water quality testing instrument, wherein the second water quality testing instrument is configured to test a second water quality parameter of a downstream of the mineralization filter element unit.

Optionally, wherein the first water quality testing instrument and the second water quality testing instrument both includes a Total Dissolved Solids tester or a conductivity meter.

Optionally, wherein a difference between the first water quality parameter and the second water quality parameter is configured to control on/off of the mineralization water circuit control valve.

Optionally, wherein a flow control unit is installed at the water inlet pipeline, according to the difference between the first water quality parameter and the second water quality parameter, a flow rate of the flow control unit varies.

Optionally, wherein the flow control unit includes valves, flow meters, regulators.

Optionally, wherein the mineralization filter element unit includes a mineralization pipeline, and a mineralization filter element is arranged on the mineralization pipeline.

Optionally, wherein the mineralization filter element unit includes: a mineralization pipeline and an inhibition pipeline which are arranged in parallel and capable of simultaneously or separately discharging water; the mineralization pipeline is provided with a mineralization filter element; the inhibition pipeline is provided with an inhibition filter element; a serially-connected switching pipeline is arranged between the mineralization pipeline and the inhibition pipeline; the serially-connected switching pipeline is configured to connect the inhibition filter element to the mineralization filter element in series; an output side of the serially-connected switching pipeline is connected to the mineralization pipeline or the mineralization filter element; an input side of the serially-connected switching pipeline is connected to the inhibition pipeline or the inhibition filter element; and a control valve is arranged on the serially-connected switching pipeline.

Optionally, wherein the mineralization filter element includes a zinc-containing filter material; and the inhibition filter element includes an alkaline filter material.

Optionally, wherein the mineralization filter element includes a first alkaline filter material; the inhibition filter element includes a second alkaline filter material; and the second alkaline filter material is configured to inhibit dissolution of an alkaline substance from the first alkaline filter material.

Optionally, wherein the mineralization filter element unit includes: a mineralization pipeline and an acceleration pipeline which are arranged in parallel and capable of simultaneously or separately discharging water; the mineralization pipeline is provided with a mineralization filter element; the acceleration pipeline is provided with an acceleration filter element; a serially-connected switching pipeline is arranged between the mineralization pipeline and the acceleration pipeline; the serially-connected switching pipeline is configured to connect the acceleration filter element to the mineralization filter element in series; an output side of the serially-connected switching pipeline is connected to the mineralization pipeline or the mineralization filter element; an input side of the serially-connected switching pipeline is connected to the acceleration pipeline or the acceleration filter element; and a control valve is arranged on the serially-connected switching pipeline.

Optionally, wherein the mineralization filter element includes a metasilicic-acid-containing filter material, and the acceleration filter element includes an alkaline filter material.

Optionally, wherein the mineralization filter element includes maifanite, and the acceleration filter element includes periclase.

Optionally, wherein the mineralization filter element unit includes: a mineralization pipeline, an inhibition pipeline, and an acceleration pipeline which are arranged in parallel and capable of simultaneously or separately discharging water; the mineralization pipeline is provided with a mineralization filter element; the inhibition pipeline is provided with an inhibition filter element; the acceleration pipeline is provided with an acceleration filter element; a first connection pipeline is arranged between the mineralization pipeline and the inhibition pipeline; an output side of the first connection pipeline is connected to the mineralization pipeline or the mineralization filter element; an input side of the first connection pipeline is connected to the inhibition pipeline or the inhibition filter element; a first control valve is arranged at the first connection pipeline; a second connection pipeline is arranged between the mineralization pipeline and the acceleration pipeline; an output side of the second connection pipeline is connected to the mineralization pipeline or the mineralization filter element; an input side of the second connection pipeline is connected to the acceleration pipeline or the acceleration filter element; and a second control valve is arranged at the second connection pipeline.

Optionally, wherein the mineralization filter element includes a metasilicic-acid-containing filter material; the acceleration filter element includes an alkaline filter material; and the inhibition filter element includes a zeolite filter material.

A second aspect of the present disclosure provides a mineralization water purifier including the mineralization waterway system.

The mineralization waterway system and the mineralization water purifier provided by the present disclosure include the pre-filter element unit, the reverse osmosis (RO) filter element unit, the mineralization filter element unit, and the water pump. By connecting the mineralization water circuit to both the mineralization filter element unit and the pre-filter element unit, the mineralized water filtered by the mineralization filter element unit is refluxed to the pre-filter element unit, and then mixed with the raw water by the pre-filter element unit. This can provide sufficient mixed water for backflushing the reverse osmosis filter element unit, enabling more thorough flushing of the filter membrane of the reverse osmosis filter element unit, thereby reducing the TDS values and effectively addressing the problem of high TDS values during short and frequent water drawings.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some of the embodiments of the present disclosure, and a person of ordinary skill in the art can still derive other drawings from the accompanying drawings without creative efforts.

FIG. 1 is a schematic structural diagram of a mineralization waterway system according to an embodiment of the present disclosure.

FIG. 2 is a schematic structural diagram of another mineralization waterway system according to an embodiment of the present disclosure.

FIG. 3 is a schematic structural diagram of still another mineralization waterway system according to an embodiment of the present disclosure.

FIG. 4 is a schematic structural diagram of water quality parameters of an upstream and a downstream of a mineralization filter element unit according to an embodiment of the present disclosure.

FIG. 5 is a schematic structural diagram of a mineralization filter element unit according to an embodiment of the present disclosure.

FIG. 6 is a schematic structural diagram of another mineralization filter element unit according to an embodiment of the present disclosure.

FIG. 7 is a schematic structural diagram of still another mineralization filter element unit according to an embodiment of the present disclosure.

FIG. 8 is a schematic structural diagram of yet another mineralization filter element unit according to an embodiment of the present disclosure.

FIG. 9 is a schematic structural diagram of a mineralization water purifier according to an embodiment of the present disclosure.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

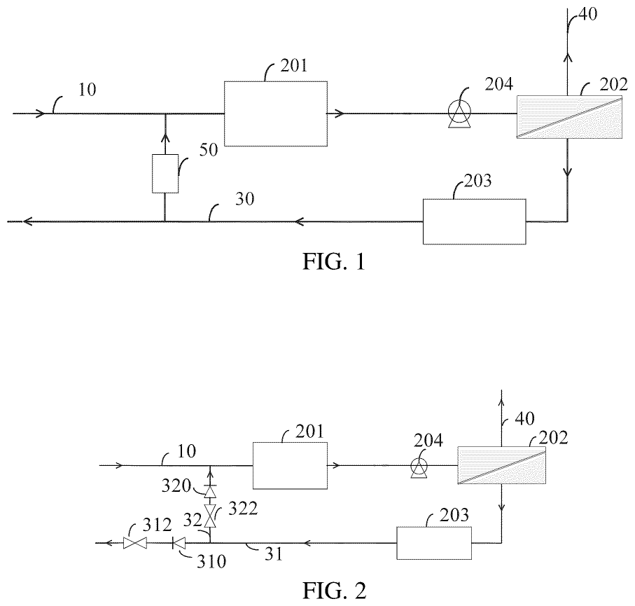

FIG. 1 is a schematic structural diagram of a mineralization waterway system according to an embodiment of the present disclosure.

A mineralization waterway system 1 includes: a water inlet pipeline 10, a pre-filter element unit 201, a reverse osmosis (RO) filter element unit 202, a mineralization filter element unit 203, and a water pump 204.

One side of the water inlet pipeline 10 is a raw water inlet side, used for flowing in raw water. The other side of the water inlet pipeline 10 is connected to a water inlet side of the pre-filter element unit 201, allowing raw water to flow into the pre-filter element unit 201 for water purification treatment. The water pump 204 is installed between the pre-filter element unit 201 and the reverse osmosis filter element unit 202. Specifically, a water inlet side of the water pump 204 is connected to a water outlet side of the pre-filter element unit 201, and a water outlet side of the water pump 204 is connected to a water inlet side of the reverse osmosis filter element unit 202. A water inlet side of the mineralization filter element unit 203 is connected to a purified water side of the reverse osmosis filter element unit 202.

In one embodiment, the pre-filter element unit 201, the water pump 204, the purified water side of the reverse osmosis filter element unit 202, and the mineralization filter element unit 203 constitute a mineralization water circuit 30. That is, the mineralization water circuit 30 is connected to the water inlet side of the reverse osmosis filter element unit 202 through the pre-filter element unit 201, to the purified water side of the reverse osmosis filter element unit 202 through the mineralization filter element unit 203, and to the water inlet side of the pre-filter element unit 201 through the mineralization filter element unit 203. Correspondingly, a process of mineralized water reflux is as follows: after passing through the water inlet pipeline 10, the raw water first passes through the pre-filter element unit 201 for preliminary filtration, and then enters the water inlet side of the reverse osmosis filter element unit 202 under a pressure of the water pump 204. The water is then filtered and purified by the reverse osmosis filter element unit 202, and followed mineralized and filtered by the mineralization filter element unit 203. Finally, the mineralized water obtained after mineralization is refluxed to the pre-filter element unit 201.

In one embodiment, a mineralization water circuit control valve 50 is installed in the mineralization water circuit 30. By opening and closing the mineralization water circuit control valve 50, a connection and a disconnection of the mineralization water circuit 30 can be controlled. When the mineralization water circuit control valve 50 is closed, the mineralization water circuit 30 is in a disconnected state, and the mineralized water flowing out from the mineralization filter element unit 203 is directly discharged through the water outlet pipeline, providing users with mineralized water for drinking. After drawing a certain volume water or for a specific duration, the water drawing process is terminated and the mineralization water circuit control valve 50 is opened, the mineralization water circuit 30 is in a connected state, thus starting a mineralized water reflux mode. The mineralized water flowing out from the mineralization filter element unit 203 is refluxed to the water inlet side of the pre-filter element unit 201 and mixed with the raw water flowing out from the water inlet pipeline 10 in a certain proportion. The mixed water flows into the reverse osmosis filter element unit 202 to flush and soak the reverse osmosis membrane with water of lower TDS (Total Dissolved Solids). Therefore, a concentration of the first glass of water next time will be lower than before, providing better TDS buffering capacity for subsequent water drawings. Thereby addressing a problem of high TDS values in the first glass of water and reducing TDS values during short and frequent water drawings. In addition, the water pump 204 can provide sufficient pressure to the reverse osmosis filter element unit 202, enabling a more thorough flushing of a filter membrane of a reverse osmosis filter element unit.

Please refer to FIG. 2, which illustrates that the mineralization water circuit 30 includes a first mineralization water branch 31 and a second mineralization water branch 32.

The first mineralization water branch 31 is connected to a water outlet side of the mineralization filter element unit 203, and used to directly discharge the mineralized water flowing out from the mineralization filter element unit 203, providing users with mineralized water for drinking. The second mineralization water branch 32 is respectively connected to one side of the first mineralization water branch 31, the water outlet side of the mineralization filter element unit 203, a water outlet side of the water inlet pipeline 10, and the water inlet side of the pre-filter element unit 201. When a mineralized water reflux mode is activated, the second mineralization water branch 32 refluxes the mineralized water flowing out from the water outlet side of the mineralization filter element unit 203 to the water inlet side of the pre-filter element unit 201, and mixes the mineralized water with the raw water flowing out from the water outlet side of the water inlet pipeline 10. The mixed water flows into the reverse osmosis filter element unit 202 to flush and soak the reverse osmosis membrane with water of lower TDS (Total Dissolved Solids). Therefore, a concentration of a first glass of water next time will be lower, providing better TDS buffering capacity for subsequent water drawings.

In one embodiment, a first one-way valve 310, a first switch valve 312 is installed in the first mineralization water branch 31.

A water inlet side of the first one-way valve 310 is connected to the water outlet side of the mineralization filter element unit 203, and a water inlet side of the first switching valve 312 is connected to a water outlet side of the first one-way valve 310. By controlling the first switch valve 312 to be in an open position, the mineralized water flowing out from the water outlet side of the mineralization filter element unit 203 can be used as drinking water for users to drink.

In one embodiment, a second one-way valve 320, a second switch valve 322 is installed in the second mineralization water branch 32. A water inlet side of the second switching valve 322 is connected to both the water inlet side of the first one-way valve 310 in the first mineralization water branch 31 and the water outlet side of the mineralization filter element unit 203. A water outlet side of the second switching valve 322 is connected to a water inlet side of the second one-way valve 320, and a water outlet side of the second one-way valve 320 is connected to the water inlet side of the pre-filter element unit 201. The water outlet side of the second one-way valve 320 is connected to the pre-filter element unit 201. The mineralized water flowing out from the mineralization filter element unit 203 passes through the second switching valve 322 and the second one-way valve 320 in the second mineralization water branch 32, in sequence, and then flows into the water inlet side of the pre-filter element unit 201. This enabling the mineralized water to be refluxed to the pre-filter element unit 201 and mixing with the tap water flowing out from the water inlet pipeline 10 in a certain proportion. The mixed water then flows into the reverse osmosis filter element unit 202 for flushing the reverse osmosis membrane.

In the embodiment, the mineralization water circuit 30 refluxes the purified water flowing out from the purified water side of the reverse osmosis filter element unit 202 to the pre-filter element unit 201 through the mineralization filter element unit 203. The purified water is mixed with the tap water in a certain proportion, and then enters the filter membrane of the reverse osmosis filter element unit 202 for flushing for a period of time. At this time, the reverse osmosis membrane is flushed and soaked with a lower TDS. Therefore, the concentration of the first glass of water next time will be relatively lower. Moreover, due to a low concentration of water entering the membrane, a concentration of water in the mineralization filter element unit becomes even lower, which will result in better TDS buffering capacity for subsequent water drawings. Thereby achieving an objective of further reducing the TDS of the first glass of water drawn next time, and effectively addressing the problem of high TDS values in the first glass of water.

As shown in FIG. 4, the mineralization waterway system 1 further includes: a first water quality testing instrument 130 and a second water quality testing instrument 132.

The first water quality testing instrument 130 can be arranged at a water inlet of the mineralization filter element unit 203. In an optional embodiment, the first water quality testing instrument 130 is arranged at the water inlet pipeline 109 of the mineralization filter element unit 203, and is configured to test a first water quality parameter of an upstream of the mineralization filter element unit 203. The second water quality testing instrument 132 can be arranged at a water outlet of the mineralization filter element unit 203. In an optional embodiment, the second water quality testing instrument 132 is arranged at the water outlet pipeline 60 of the mineralization filter element unit 203, and is configured to test a second water quality parameter of a downstream of the mineralization filter element unit 203.

A water quality testing instrument (the first water quality testing instrument 130 and the second water quality testing instrument 132) can be a Total Dissolved Solids (TDS) tester or can be a conductivity meter. When the first water quality testing instrument 130 and the second water quality testing instrument 132 are the TDS testers, correspondingly, the first water quality parameter is a first TDS value, and the second water quality parameter is a second TDS value. When the first water quality testing instrument 130 and the second water quality testing instrument 132 are the conductivity meters, correspondingly, the first water quality parameter is a first conductivity value, and the second water quality parameter is a second conductivity value.

A total dissolved solids (TDS) value is a total amount of solids dissolved in water, including a content of inorganic substances and a content of organic substances. A measurement unit is milligrams per liter (1 mg/L=1 ppm), indicating how many milligrams of dissolved total solids are dissolved in a liter of water. A larger TDS value indicates more dissolved matters contained in the water. Generally, a conductivity value can be used to roughly understand a salt content of the solution. A higher conductivity indicates a higher salt content and a larger TDS value. The higher conductivity indicates that an ion concentration of the water is high, which can contain more dissolved matters.

In an embodiment, the first water quality testing instrument 130 and the second water quality testing instrument 132 are respectively electrically connected to a control module. The first water quality testing instrument 130 transmits the detected first water quality parameter to the control module, and the second water quality testing instrument 132 transmits the detected second water quality parameter to the control module.

After obtaining the first water quality parameter and the second water quality parameter, the control module can calculate a pH value of the water quality according to the second water quality parameter and the first water quality parameter, and then control the opening or closing of the mineralization water circuit control valve 50 according to the pH value of the water, thereby controlling the mineralization water circuit 30 to be in a connected or disconnected state. Specifically, the control module determines whether the pH value of the water is higher than a preset pH threshold. When the pH value of the water is determined to be higher than the preset pH threshold, the control module can control the mineralization water circuit control valve 50 to close, so that the mineralization water circuit 30 is in a disconnected state. When the pH value of the water is determined to be lower than the preset pH threshold, the control module can control the mineralization water circuit control valve 50 to open, so that the mineralization water circuit 30 is in a connected state.

In an embodiment, the control module calculates and obtains a water quality parameter difference according to the second water quality parameter and the first water quality parameter, and can obtain the pH value of the water obtained by the mineralization filter element unit 203 according to a corresponding relationship between preset water quality parameter differences and pH values of water. The corresponding relationship is a mathematical function obtained by fitting a relationship between the water quality parameter difference and the pH value using a data fitting method (such as linear regression, polynomial regression, and a machine learning algorithm).

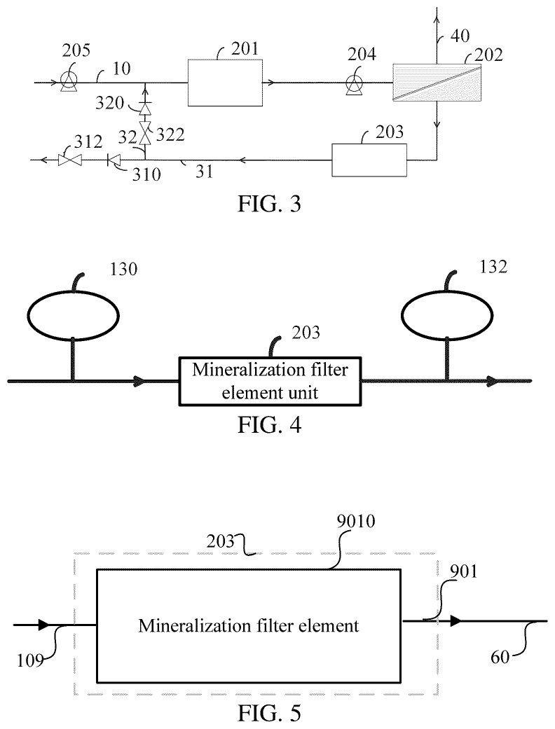

Referring to FIG. 2 and FIG. 3 together, a flow control unit 205 is installed at the water inlet pipeline 10 to regulate and control the water flow entering the mineralization waterway system 1.

In one embodiment, the flow control unit 205 can include valves, flow meters, regulators, etc., to achieve precise flow control.

According to a difference between the first water quality parameter and the second water quality parameter, a flow rate of the flow control unit 205 varies. In specific applications, the control module calculates the pH value of the water based on the difference between the first water quality parameter and the second water quality parameter, and controls the flow rate of the flow control unit 205 accordingly based on different pH values.

For example, if the pH value of the water is lower than a first preset threshold or higher than a second preset threshold, indicating that the water is too acidic or too alkaline, the control module can control the flow control unit 205 to reduce or increase the flow rate to optimize a mineralization treatment effect of the mineralization filter element unit 203. According to a decision of the control module, the flow control unit 205 adjusts its opening or working mode to change the water flow entering the mineralization waterway system 1. This adjustment can be continuous or graded.

By precisely controlling the flow rate, it can ensure that the water quality maintains an optimal pH range during the treatment process, thereby improving the treatment effect. This avoids damage to equipment caused by excessively acidic or alkaline water quality and prolongs a lifespan of the equipment. By optimizing flow control, unnecessary energy consumption and water resource waste can be reduced.

Referring to FIG. 5, the mineralization filter element unit 203 includes a mineralization pipeline 901, and a mineralization filter element 9010 is arranged on the mineralization pipeline 901.

The mineralization pipeline 901 is a channel through which water flows, to ensure smooth and efficient flowing through of water, without introducing any pollutants.

The mineralization filter element 9010 is responsible for adding beneficial minerals into water, to enhance the taste and nutritional value of the water. The mineralization filter element 9010 can be made of various materials, including but not limited to maifanite, tourmaline, weakly alkaline mineralization spheres, and the like.

In practical applications, when flowing through the mineralization filter element unit 203, pure water flowing out of a pure water side of the first filter element unit 30 and/or the second filter element unit 40, pure water can first enter the mineralization pipeline 901 and then flow through the mineralization filter element 9010. The water is in contact with and exchanges with a material in the mineralization filter element 9010, thereby absorbing beneficial minerals. After mineralization, the taste and nutritional value of the water can be improved, so that the water is more suitable for drinking.

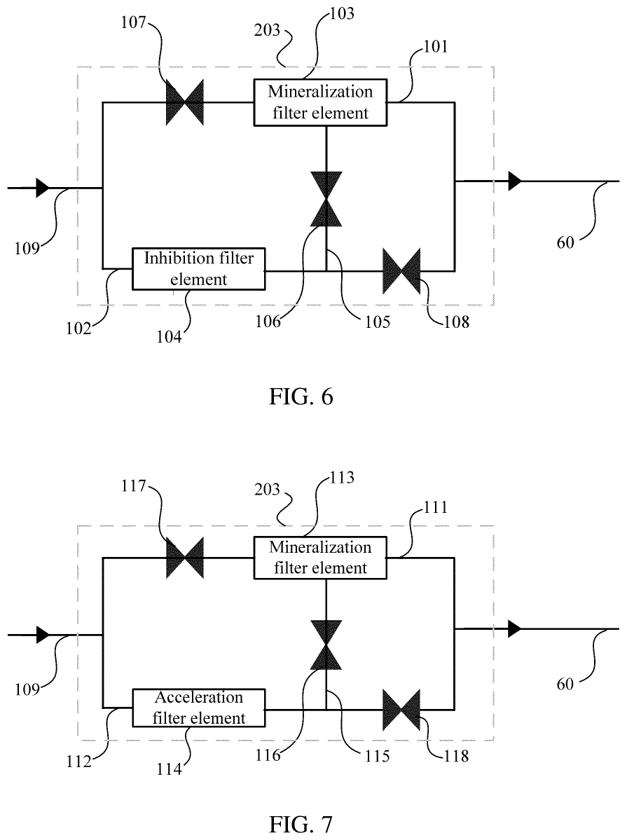

As shown in FIG. 6, the mineralization filter element unit 203 includes a mineralization pipeline 101 and an inhibition pipeline 102. The mineralization pipeline 101 is provided with a mineralization filter element 103, and the inhibition pipeline 102 is provided with an inhibition filter element 104.

In an optional embodiment, the mineralization pipeline 101 and the inhibition pipeline 102 are arranged in parallel and can simultaneously output water. Specifically, the mineralization pipeline 101 and the inhibition pipeline 102 are connected in parallel between the water inlet pipeline 109 of the mineralization filter element unit 203 and the water outlet pipeline 60 of the mineralization filter element unit 203. The water inlet pipeline 109 can be connected to the mineralization pipeline 101 and the inhibition pipeline 102 through a three-way valve or a flow divider valve, and the mineralization pipeline 101 and the inhibition pipeline 102 can be connected to the water outlet pipeline 60 through a three-way valve. When the mineralization pipeline 101 and the inhibition pipeline 102 simultaneously output water, the water from the mineralization pipeline 101 and the inhibition pipeline 102 can be mixed and then discharged through the water outlet pipeline 60.

The mineralization filter element 103 is arranged in the mineralization pipeline 101, and the mineralization filter element 103 can release (dissolve) minerals into the water flowing therethrough, thereby making the water output from the mineralization pipeline 101 contain minerals, to meet a requirement of people for mineralized drinking water. The inhibition filter element 104 is arranged in the inhibition pipeline 102, and the inhibition filter element 104 can release an inhibitory substance into the water flowing therethrough. When the water containing the inhibitory substance flows through the mineralization filter element 103, the inhibitory substance can inhibit the dissolution of the minerals in the mineralization filter element 103, thereby avoiding a situation that the mineral content of the water is high.

In an optional embodiment, the mineralization filter element unit 203 further includes a serially-connected switching pipeline 105. The serially-connected switching pipeline 105 is arranged between the mineralization pipeline 101 and the inhibition pipeline 102 and is configured to connect the inhibition filter element 104 to the mineralization filter element 103 in series. An output end of the serially-connected switching pipeline 105 is connected to the mineralization pipeline 101 or the mineralization filter element 103, and an input end of the serially-connected switching pipeline 105 is connected to the inhibition pipeline 102 or the inhibition filter element 104.

The output end of the serially-connected switching pipeline 105 is connected to the mineralization pipeline 101 or the mineralization filter element 103, and the input end of the serially-connected switching pipeline 105 is connected to the inhibition pipeline 102 or the inhibition filter element 104, so that a mineralization structure in which the inhibition filter element 104 is located upstream and the mineralization filter element 103 is located downstream can be formed, and the water containing the inhibitory substance is made to flow through a waterway of the mineralization filter element 103.

In specific implementation, to prevent a high mineral content of the water, the water containing the inhibitory substance can flow through the mineralization filter element 103 through the serially-connected switching pipeline 105 to inhibit the release of the minerals from the mineralization filter element 103 and meet a requirement for reducing the mineral content of the water. When the mineralization filter element 103 is in a soaked state, for example, if the water in the mineralization pipeline 101 flows too slowly, or if outputting of water stops, or after outputting of water stops for a set duration, it can cause the mineral content of the water (especially in the mineralization filter element 103) to be too high. By using the serially-connected switching pipeline 105, the water containing the inhibitory substance can enter the mineralization filter element 103, thereby inhibiting the mineralization filter element 103 in the soaked state from releasing minerals and avoiding an excessive mineral content of the water. The soaked state described in this embodiment means a situation that a flow rate in the filter element is less than a design threshold, including a situation that water stops flowing, the flowing is slow, or the like.

In an optional embodiment, a first control valve 106 is arranged at the serially-connected switching pipeline 105.

The first control valve 106 has a state of allowing water to flow through and a state of not allowing water to flow through. In specific applications, the first control valve 106 can also be a flow valve. Since the first control valve 106 is arranged at the serially-connected switching pipeline 105, it is possible to control whether the water can flow through the serially-connected switching pipeline 105 from the inhibition filter element 104 to the mineralization filter element 103. For example, when the mineralization filter element 103 is in the soaked state, the first control valve 106 can be made in the state of allowing water to flow through. Therefore, the water can flow from the inhibition filter element 104 to the mineralization filter element 103 through the serially-connected switching pipeline 105, thereby inhibiting the mineralization filter element 103 from releasing the minerals, to reduce the mineral content of the water, prevent the mineral content from exceeding a set standard, and control the mineral content in a safe standard range. When a flow rate of the water flowing through the mineralization pipeline 101 exceeds a set flow rate, a concentration of the minerals in the water flowing through the mineralization filter element 103 can not exceed a set standard. When the mineral content of the water does not need to be reduced, the first control valve 106 can be made in the state of not allowing water to flow through.

In an optional embodiment, the mineralization filter element unit 203 further includes a second control valve 107. The second control valve 107 is arranged at the mineralization pipeline 101 and is located at an upstream end of the mineralization filter element 103.

The second control valve 107 is configured to control the mineralization pipeline 101 to be in a connected or disconnected state and/or control a flow rate of the mineralization pipeline 101. By controlling opening or closing of the second control valve 107, it is possible to determine whether to convey water to the mineralization filter element 103. The flow rate of the mineralization pipeline 101 is controlled through the second control valve 107, so that an amount of minerals released by the mineralization filter element 103 into water per unit volume can be controlled. Specifically, when the flow rate of water in the mineralization pipeline 101 is greater than a set flow rate, the mineral content of water per unit volume can decrease. When the flow rate of water in the mineralization pipeline 101 is less than the set flow rate, the mineral content of water per unit volume can increase. Therefore, the flow rate of the mineralization pipeline 101 can be adjusted through the second control valve 107, thereby adjusting the mineral content of the water in the mineralization pipeline 101.

The output end of the serially-connected switching pipeline 105 is connected between the second control valve 107 and the mineralization filter element 103. In this way, the output end of the serially-connected switching pipeline 105 is connected to an upstream end of the mineralization filter element 103, which can achieve flowing of water in the serially-connected switching pipeline 105 to the mineralization filter element 103.

In an optional embodiment, the mineralization filter element unit 203 further includes a third control valve 108. The third control valve 108 is arranged at the inhibition pipeline 102 and is located at a downstream end of the inhibition filter element 104.

The third control valve 108 is configured to control the inhibition pipeline 102 to be in a connected or disconnected state and/or control a flow rate of the inhibition pipeline 102. The input end of the serially-connected switching pipeline 105 is connected between the inhibition filter element 104 and the third control valve 108. In this way, the input end of the serially-connected switching pipeline 105 is connected to the downstream end of the inhibition filter element 104. When the third control valve 108 is closed, and the first control valve 106 is opened, the water containing the inhibitory substance can flow to the serially-connected switching pipeline 105, and then the water containing the inhibitory substance flows to the mineralization filter element 103.

By controlling the opening or closing of the second control valve 107 and the opening or the closing of the third control valve 108, as well as controlling the state of the first control valve 106 of whether to allow water to flow through, it is possible to achieve that the mineralization pipeline 101 and the inhibition pipeline 102 output water simultaneously or separately, and the water flowing through the inhibition filter element 104 can enter the mineralization filter element 103 through the serially-connected switching pipeline 115.

For example, when the mineralization pipeline 101 and the inhibition pipeline 102 need to output water simultaneously, the second control valve 107 and the third control valve 108 can be controlled to be opened, and the first control valve 106 can be closed. In this case, the serially-connected switching pipeline 105 is blocked, and the mineralization pipeline 101 and the inhibition pipeline 102 are connected in parallel. The water containing the minerals in the mineralization pipeline 101 and the water containing the inhibitory substance in the inhibition pipeline 102 can be mixed in the water outlet pipeline 60 and then discharged.

For another example, when the mineralization pipeline 101 needs to output water separately, the second control valve 107 can be controlled to be opened, and the first control valve 106 and the third control valve 108 can be closed. In this case, the mineralization pipeline 101 is unblocked, and the inhibition pipeline 102 and the serially-connected switching pipeline 105 are both blocked. The water containing the minerals in the mineralization pipeline 101 can be discharged through the water outlet pipeline 60.

For still another example, when the mineralization filter element 103 is in the soaked state, the second control valve 107 and the third control valve 108 can be controlled to be closed, and the first control valve 106 can be opened. In this case, the inhibition filter element 104 and the mineralization filter element 103 are connected to each other through the serially-connected switching pipeline 105, and the water containing the inhibitory substance can flow to the mineralization filter element 103 through the serially-connected switching pipeline 105.

In an optional embodiment, the first control valve 106, the second control valve 107, and the third control valve 108 are all electromagnetic valves. Of course, in other embodiments, the first control valve 106, the second control valve 107, and the third control valve 108 can further use other valves.

In an optional embodiment, the mineralization filter element 103 includes a zinc-containing filter material (e.g., smithsonite and hydrozincite), and the inhibition filter element 104 includes an alkaline filter material (e.g., magnesite, brucite, sepiolite, and calcite). Zinc plays an indispensable role in cell replication, immune activity, and tissue repair and growth, and is a key element in growth, reproductive genetics, immune systems, and bone metabolism. Therefore, configuring the mineralization filter element 103 to include the zinc-containing filter material can release mineral zinc into water, which is beneficial to the health of people. In addition, water with a pH value between 7.0 and 9.0 is the best for the health of a human body. Configuring the inhibition filter element 104 to include the alkaline filter material is beneficial for maintaining the water within the pH range of 7.0 to 9.0.

It should be noted that zinc is one of the essential trace elements for the human body, and it helps growth and can further participate in vitamin metabolism. However, when a zinc content of drinking water exceeds a standard, it can lead to excessive zinc intake in a human body, which can cause harms to the human body, such as zinc poisoning and abnormal lipid metabolism. Therefore, the inhibition filter element 104 is configured to inhibit excessive release of zinc, a high zinc concentration can be avoided.

It can be understood that in other embodiments, the mineralization filter element 103 can further include a filter material containing other minerals, such as copper, calcium, magnesium, potassium, and strontium. It should be noted that when the mineralization filter element 103 includes the filter material containing other minerals, a corresponding inhibition filter material is matched in the inhibition filter element 104.

In an optional embodiment, the mineralization filter element 103 includes a first alkaline filter material, and the inhibition filter element 104 includes a second alkaline filter material. An alkalinity of the first alkaline filter material is less than an alkalinity of the second alkaline filter material, and the alkalinity of the second alkaline filter material is greater than the alkalinity of the first alkaline filter material. Therefore, the second alkaline filter material can be configured to suppress dissolution of an alkaline substance from the first alkaline filter material. For example, the first alkaline filter material (weakly alkaline) contains maifanite or tourmaline, and the second alkaline filter material (strongly alkaline) contains zinc with a high concentration and magnesium with a high concentration.

Weakly alkaline ores are arranged in the first alkaline filter material, and strongly alkaline ores are arranged in the second alkaline filter material. When water flows through the first alkaline filter material first, an alkaline substance precipitated from the first alkaline filter material can increase the pH value of the water. Afterwards, when the water flows into the inhibition filter element 104, since the pH value of the water has been increased by the first alkaline filter material, the precipitation of the minerals such as zinc and copper in the second alkaline filter material can be inhibited to an extent (usually because the solubility or precipitation rate of these minerals decreases at a higher pH value).

By using the above filter element unit 203, when the water has a high mineral content, the mineral content of the water can be reduced by inhibiting the release or dissolution of the minerals in the mineralization filter element through the inhibition filter element.

As shown in FIG. 7, the mineralization filter element unit 203 includes a mineralization pipeline 111 and an acceleration pipeline 112. The mineralization pipeline 111 is provided with a mineralization filter element 113, and the acceleration pipeline 112 is provided with an acceleration filter element 114.

In an optional embodiment, the mineralization pipeline 111 and the acceleration pipeline 112 are arranged in parallel and can simultaneously output water. Specifically, the mineralization pipeline 111 and the acceleration pipeline 112 are connected in parallel between the water inlet pipeline 109 of the mineralization filter element unit 203 and the water outlet pipeline 60 of the mineralization filter element unit 203. The water inlet pipeline 109 can be connected to the mineralization pipeline 111 and the acceleration pipeline 112 through a three-way valve or a flow divider valve, and the mineralization pipeline 111 and the acceleration pipeline 112 can be connected to the water outlet pipeline 60 through a three-way valve. When the mineralization pipeline 111 and the acceleration pipeline 112 simultaneously output water, the water from the mineralization pipeline 111 and the acceleration pipeline 112 can be mixed and then discharged through the water outlet pipeline 60.

The mineralization filter element 113 is arranged in the mineralization pipeline 111, and the mineralization filter element 113 can release (dissolve) minerals into the water flowing therethrough, thereby making the water output from the mineralization pipeline 111 contain minerals, to meet a requirement of people for mineralized drinking water. The acceleration filter element 114 is arranged in the acceleration pipeline 112, and the acceleration filter element 114 can release an accelerant into the water flowing therethrough. When the water containing the accelerant flows through the mineralization filter element 113, the accelerant can accelerate the dissolution of the minerals in the mineralization filter element 113, thereby increasing the mineral content of the water.

In an optional embodiment, the mineralization filter element unit 203 further includes a serially-connected switching pipeline 115. The serially-connected switching pipeline 115 is arranged between the mineralization pipeline 111 and the acceleration pipeline 112 and is configured to connect the acceleration filter element 114 to the mineralization filter element 113 in series. An output end of the serially-connected switching pipeline 115 is connected to the mineralization pipeline 111 or the mineralization filter element 113, and an input end of the serially-connected switching pipeline 115 is connected to the acceleration pipeline 112 or the acceleration filter element 114.

The output end of the serially-connected switching pipeline 115 is connected to the mineralization pipeline 111 or the mineralization filter element 113, and the input end of the serially-connected switching pipeline 115 is connected to the acceleration pipeline 112 or the acceleration filter element 114, so that a mineralization structure in which the acceleration filter element 114 is located upstream and the mineralization filter element 113 is located downstream can be formed, and the water containing the accelerant is made to flow through a waterway of the mineralization filter element 113.

Since the water containing the accelerant flows into the mineralization filter element 113, the accelerant can accelerate the release of the minerals from the mineralization filter element 113, thereby increasing the mineral content of the water and then avoiding that the mineral content of the water does not meet a standard. For example, when the flow rate of the water in the mineralization pipeline 111 exceeds a set flow rate (i.e., the flow rate of the water is large), the flow speed of the water increases, and the release amount of the minerals in water per unit volume can decrease. By using the serially-connected switching pipeline 115, the water containing the accelerant flows into the mineralization filter element 113 to accelerate the release of the minerals from the mineralization filter element 113, which can increase the mineral content of the water. When the mineralization filter element 113 has been used for a period of time and reaches the middle to late stage of its service life, the performance of the mineralization filter element 113 for releasing minerals decreases. The accelerant is used to accelerate the release of minerals from the mineralization filter element 113, so that the mineral content of the water can be effectively increased, and the minerals in the water can meet a standard. Furthermore, the service life of the mineralization filter element 113 can be prolonged.

In an optional embodiment, a first control valve 116 is arranged at the serially-connected switching pipeline 115.

The first control valve 116 has a state of allowing water to flow through and a state of not allowing water to flow through. In specific applications, the first control valve 116 can also be a flow valve. Since the first control valve 116 is arranged at the serially-connected switching pipeline 115, it is possible to control whether the water can flow through the serially-connected switching pipeline 115 from the acceleration filter element 114 to the mineralization filter element 113. When the water in the mineralization pipeline 111 has a large flow rate, or when the mineralization filter element 113 has reached the middle to late stage of its service life, the first control valve 116 can be in the state of allowing water to flow through. In this case, the water can flow from the acceleration filter element 114 to the mineralization filter element 113 through the serially-connected switching pipeline 115, thereby increasing the release amount of minerals from the mineralization filter element 113, to increase the mineral content of the water, prevent the mineral content from being less than a set standard, and control the mineral content in a safe standard range. When the flow rate of the water in the mineralization pipeline 111 is less than a set flow rate, or when the mineralization filter element 113 has reached the middle to late stage of its service life, a concentration of the minerals in the water that flows through the mineralization filter element 113 can not be less than a set standard. When the mineral content of the water meets the standard, the first control valve 116 can be in the state of not allowing water to flow through.

In an optional embodiment, the mineralization filter element unit 203 further includes a second control valve 117. The second control valve 117 is arranged at the mineralization pipeline 111 and is located at an upstream end of the mineralization filter element 113.

The second control valve 117 is configured to control the mineralization pipeline 111 to be in a connected or disconnected state and/or control a flow rate of the mineralization pipeline 111. By controlling opening or closing of the second control valve 117, it is possible to determine whether to convey water to the mineralization filter element 113. The flow rate of the mineralization pipeline 111 is controlled through the second control valve 117, so that an amount of minerals released by the mineralization filter element 113 into water per unit volume can be controlled. Specifically, when the flow rate of water in the mineralization pipeline 111 is greater than a set flow rate, the mineral content of water per unit volume can decrease. When the flow rate of water in the mineralization pipeline 111 is less than the set flow rate, the mineral content of water per unit volume can increase. Therefore, the flow rate of the mineralization pipeline 111 can be adjusted through the second control valve 117, thereby adjusting the mineral content of the water in the mineralization pipeline 111.

The output end of the serially-connected switching pipeline 115 is connected between the second control valve 117 and the mineralization filter element 113. In this way, the output end of the serially-connected switching pipeline 115 is connected to an upstream end of the mineralization filter element 113, which can achieve flowing of water in the serially-connected switching pipeline 115 to the mineralization filter element 113.

In an optional embodiment, the mineralization filter element unit 203 further includes a third control valve 118. The third control valve 118 is arranged at the acceleration pipeline 112 and is located at a downstream end of the acceleration filter element 114.

The third control valve 118 is configured to control the acceleration pipeline 112 to be in a connected or disconnected state and/or control a flow rate of the acceleration pipeline 112. The input end of the serially-connected switching pipeline 115 is connected between the acceleration filter element 114 and the third control valve 118. In this way, the input end of the serially-connected switching pipeline 115 is connected to the downstream end of the acceleration filter element 114. When the third control valve 118 is closed, and the first control valve 116 is opened, the water containing the accelerant can flow to the serially-connected switching pipeline 115, and then the water containing the accelerant flows to the mineralization filter element 113.

By controlling the opening or closing of the second control valve 117 and the opening or the closing of the third control valve 118, as well as controlling the state of the first control valve 116 of whether to allow water to flow through, it is possible to achieve that the mineralization pipeline 111 and the acceleration pipeline 112 output water simultaneously or separately, and the water flowing through the acceleration filter element 114 can enter the mineralization filter element 113 through the serially-connected switching pipeline 115.

For example, when the mineralization pipeline 111 and the acceleration pipeline 112 need to output water simultaneously, the second control valve 117 and the third control valve 118 can be controlled to be opened, and the first control valve 116 can be closed. In this case, the serially-connected switching pipeline 115 is blocked, and the mineralization pipeline 111 and the acceleration pipeline 112 are connected in parallel. The water containing the minerals in the mineralization pipeline 111 and the water containing the accelerant in the acceleration pipeline 112 can be mixed in the water outlet pipeline 60 and then discharged.

For another example, when the mineralization pipeline 111 needs to output water separately, the second control valve 117 can be controlled to be opened, and the first control valve 116 and the third control valve 118 can be closed. In this case, the mineralization pipeline 111 is unblocked, and the acceleration pipeline 112 and the serially-connected switching pipeline 115 are both blocked. The water containing the minerals in the mineralization pipeline 111 can be discharged through the water outlet pipeline 60.

For another example, when the mineralization filter element 113 is in the middle to late stage of its service life, the first control valve 116 can be controlled to be opened, and the second control valve 117 and the third control valve 118 can be controlled to be closed. In this case, the acceleration filter element 114 and the mineralization filter element 113 are connected through the serially-connected switching pipeline 115, and the water containing the accelerant can flow to the mineralization filter element 113 through the serially-connected switching pipeline 115, thereby accelerating the release of minerals from the mineralization filter element 113, to make the minerals in the water meet the standard. Even if the mineralization filter element 113 is in the middle to late stage of its lifespan (the dissolution rate of minerals decreases), by using the acceleration filter element 114, the dissolution rate of the minerals in the mineralization filter element 113 is maintained within a set range, and the service life of the mineralization filter element 113 can be prolonged. Or, even in a large flow rate, the first control valve 116 can be controlled to be opened, and the second control valve 117 and the third control valve 118 can be controlled to be closed, so that the minerals in the water can meet the standard at the large flow rate.

In an optional embodiment, the first control valve 116, the second control valve 117, and the third control valve 118 are all electromagnetic valves. Of course, in other embodiments, the first control valve 116, the second control valve 117, and the third control valve 118 can further use other valves.

In an optionally embodiment, the mineralization filter element 113 includes a metasilicic-acid-containing filter material, and the acceleration filter element 114 includes an alkaline filter material. Silicon is one of the essential trace elements for a human body, and it tends to decrease significantly with age in the human body. Modern medicine has shown that silicon has an impact on synthesis of bone tissues and is related to bone growth and bone structures. Silicon plays a physiological role in the process of bone calcification and can promote bone growth. Insufficient intake of silicon can lead to a decrease in bone calcium content. Lack of silicon in a body can further lead to growth retardation, resulting in skeletal abnormalities, deformities (especially in the skull), and underdeveloped teeth or enamel. Silicon can further enhance the strength of elastic fibers of blood vessels, especially intimal elastic layers, thereby forming a barrier that effectively hinders lipid invasion. This property enables silicon to have an effect of resisting atherosclerosis, can maintain the integrity of the elastic fibers and mesenchyme, and thus prevent formation of atherosclerotic plaques. Silicon can further remove fat deposited on inner walls of blood vessels. This mechanism can alleviate arteriosclerosis and cardiovascular and heart diseases.

Silicon required by a human body generally comes from water, and the silicon in the water exists in the form of metasilicic acid, so that it is easily absorbed by the human body and the skin. Therefore, since the mineralization filter element 113 contains the metasilicic-acid-containing filter material, the mineralization filter element 113 can release metasilicic acid into the water, which is beneficial to the health of the human body.

In addition, water with a pH value between 7.0 and 9.0 is the best for the health of the human body. Configuring the acceleration filter element 114 to include the alkaline filter material is beneficial for maintaining the water within the pH range of 7.0 to 9.0, which is then beneficial to the health of the human body.

It can be understood that in other embodiments, the mineralization filter element 113 can further include a filter material containing other minerals, such as copper, calcium, magnesium, potassium, strontium, and zinc. It should be noted that when the mineralization filter element 113 includes the filter material containing other minerals, a corresponding acceleration filter material is matched in the acceleration filter element 114.

In an optional embodiment, the mineralization filter element 113 includes maifanite, and the acceleration filter element 114 includes periclase. By using the maifanite as the filter material of the mineralization filter element 113, the metasilicic acid that is beneficial for the human body can be released, without producing harmful substances to the human body.

By using the above filter element unit 203, when the water has a low mineral content, the mineral content of the water can be increased by accelerating the release or dissolution of the minerals in the mineralization filter element through the acceleration filter element.

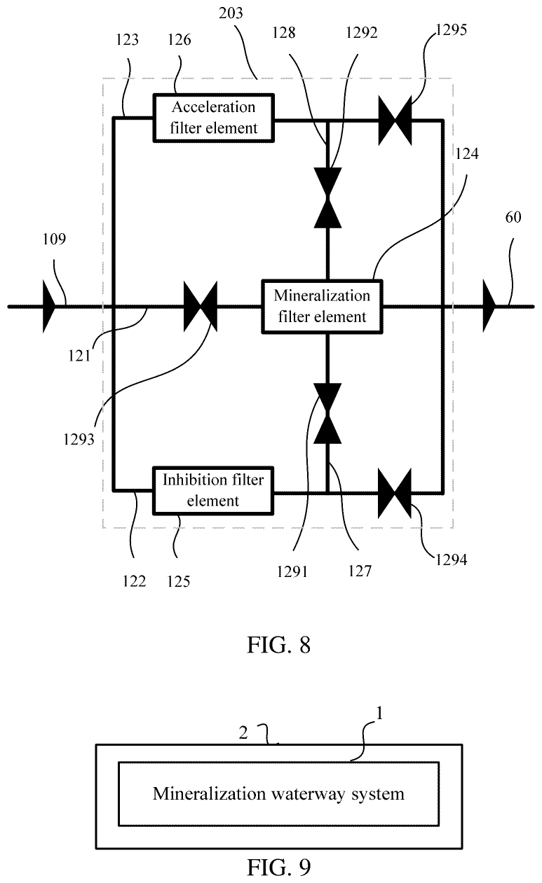

As shown in FIG. 8, the mineralization filter element unit 203 includes a mineralization pipeline 121, an inhibition pipeline 122, and an acceleration pipeline 123. The mineralization pipeline 121 is provided with a mineralization filter element 124. The inhibition pipeline 122 is provided with an inhibition filter element 125. The acceleration pipeline 123 is provided with an acceleration filter element 126.

In an optional embodiment, the mineralization pipeline 121, the inhibition pipeline 122, and the acceleration pipeline 123 are arranged in parallel and can simultaneously output water. Specifically, the mineralization pipeline 121, the inhibition pipeline 122, and the acceleration pipeline 123 are connected in parallel between the water inlet pipeline 109 of the mineralization filter element unit 203 and the water outlet pipeline 60 of the mineralization filter element unit 203. The water inlet pipeline 109 can be connected to the mineralization pipeline 121, the inhibition pipeline 122, and the acceleration pipeline 123 through a multi-way valve or a flow divider valve, and the mineralization pipeline 121, the inhibition pipeline 122, and the acceleration pipeline 123 can be connected to the water outlet pipeline 60 through a multi-way valve. When the mineralization pipeline 121, the inhibition pipeline 122, and the acceleration pipeline 123 simultaneously output water, the water from the mineralization pipeline 121, the inhibition pipeline 122, and the acceleration pipeline 123 can be mixed and then discharged through the water outlet pipeline 60.

The mineralization filter element 124 is arranged in the mineralization pipeline 121, and the mineralization filter element 124 can release (dissolve) minerals into the water flowing therethrough, thereby making the water output from the mineralization pipeline 121 contain minerals, to meet a requirement of people for mineralized drinking water. The inhibition filter element 125 is arranged in the inhibition pipeline 122, and the inhibition filter element 125 can release an inhibitory substance into the water flowing therethrough. When the water containing the inhibitory substance flows through the mineralization filter element 124, the inhibitory substance can inhibit the dissolution of the minerals in the mineralization filter element 124, thereby avoiding a situation that the mineral content of the water is high. The acceleration filter element 126 is arranged in the acceleration pipeline 123, and the acceleration filter element 126 can release an accelerant into the water flowing therethrough. When the water containing the accelerant flows through the mineralization filter element 124, the accelerant can accelerate the dissolution of the minerals in the mineralization filter element 124, thereby increasing the mineral content of the water.

In an optional embodiment, the mineralization filter element unit 203 further includes a first connection pipeline 127. The first connection pipeline 127 is arranged between the mineralization pipeline 121 and the inhibition pipeline 122 and is configured to connect the inhibition filter element 125 to the mineralization filter element 124 in series. An output end of the first connection pipeline 127 is connected to the mineralization pipeline 121 or the mineralization filter element 124, and an input end of the first connection pipeline 127 is connected to the inhibition pipeline 122 or the inhibition filter element 125. In this way, a mineralization structure in which the inhibition filter element 125 is located upstream and the mineralization filter element 124 is located downstream can be formed, and the water containing the inhibitory substance flows through a waterway of the mineralization filter element 124.

In an optional embodiment, the mineralization filter element unit 203 further includes a second connection pipeline 128. The second connection pipeline 128 is arranged between the mineralization pipeline 121 and the acceleration pipeline 123 and is configured to connect the acceleration filter element 126 to the mineralization filter element 124 in series. An output end of the first connection pipeline 127 is connected to the mineralization pipeline 121 or the mineralization filter element 124, and an input end of the first connection pipeline 127 is connected to the acceleration pipeline 123 or the acceleration filter element 126. In this way, a mineralization structure in which the promotion filter element 126 is located upstream and the mineralization filter element 124 is located downstream can be formed, and the water containing the accelerant flows through the waterway of the mineralization filter element 124.

In an optional embodiment, a first control valve 1291 is arranged at the first connection pipeline 127. The first control valve 1291 has a state of allowing water to flow through and a state of not allowing water to flow through. In specific applications, the first control valve 1291 can also be a flow valve.

In an optional embodiment, a second control valve 1292 is arranged at the second connection pipeline 128. The second control valve 1292 has a state of allowing water to flow through and a state of not allowing water to flow through. In specific applications, the second control valve 1292 can also be a flow valve.

In an optional embodiment, the mineralization pipeline 121 is provided with a third control valve 1293 for controlling the mineralization pipeline 121 to be in a connected or disconnected state and/or for controlling a flow rate of the mineralization pipeline 121. The third control valve 1293 is arranged at an upstream end of the mineralization filter element 124.

In an optional embodiment, the inhibition pipeline 122 is provided with a fourth control valve 1294 for controlling the inhibition pipeline 122 to be in a connected or disconnected state and/or for controlling a flow rate of the inhibition pipeline 122. Since the fourth control valve 1294 is arranged at the downstream end of the inhibition filter element 125, it can be achieved whether to convey water to the inhibition filter element 125 by controlling opening or closing of the fourth control valve 1294.

In an optional embodiment, the acceleration pipeline 123 is provided with a fifth control valve 1295 for controlling the acceleration pipeline 123 to be in a connected or disconnected state and/or for controlling a flow rate of the acceleration pipeline 123. Since the fifth control valve 1295 is arranged at the downstream end of the acceleration filter element 126, it can be achieved whether to convey water to the acceleration filter element 126 by controlling opening or closing of the fifth control valve 1295.

One end of the first connection pipeline 127 is connected between the third control valve 1293 and the mineralization filter element 124, and the other end of the first connection pipeline 127 is connected between the inhibition filter element 125 and the fourth control valve 1294. Since the third control valve 1293 is arranged at the upstream end of the mineralization filter element 124 and the fourth control valve 1294 is arranged at the downstream end of the inhibition filter element 125, the input end of the first connection pipeline 127 is connected to the downstream end of the inhibition filter element 125, and the output end of the first connection pipeline 127 is connected to the upstream end of the mineralization filter element 124. When the third control valve 1293 and the fourth control valve 1294 are controlled to be closed, and the first control valve 1291 is in the state of allowing water to flow through, the water containing the inhibitory substance can flow to the first connection pipeline 127 and then to the mineralization filter element 124.

One end of the second connection pipeline 128 is connected between the third control valve 1293 and the mineralization filter element 124, and the other end of the second connection pipeline 128 is connected between the acceleration filter element 126 and the fifth control valve 1295. Since the third control valve 1293 is arranged at the upstream end of the mineralization filter element 124 and the fifth control valve 1295 is arranged at the downstream end of the acceleration filter element 126, the input end of the second connection pipeline 128 is connected to the downstream end of the acceleration filter element 126, and the output end of the second connection pipeline 128 is connected to the upstream end of the mineralization filter element 124. When the third control valve 1293 and the fifth control valve 1295 are controlled to be closed, and the second control valve 1292 is in the state of allowing water to flow through, the water containing the accelerant can flow to the second connection pipeline 128 and then to the mineralization filter element 124.

By controlling the opening or closing of the first control valve 1291, the second control valve 1292, the third control valve 1293, the fourth control valve 1294, and the fifth control valve 1295, at least two of the mineralization pipeline 121, the inhibition pipeline 122, and the acceleration pipeline 123 can be simultaneously or separately output water, and the water flowing through the inhibition filter element 125 can enter the mineralization filter element 124 through the first connection pipeline 127, or the water flowing through the acceleration filter 126 can enter the mineralization filter element 124 through the second connection pipeline 128, to make pipeline structures meet different requirements.

For example, when the mineralization pipeline 121, the inhibition pipeline 122, and the acceleration pipeline 123 need to output water simultaneously, the third control valve 1293, the fourth control valve 1294, and the fifth control valve 1295 can be controlled to be opened, and the first control valve 1291 and the second control valve 1292 can be controlled to be in the state of not allowing water to pass through. In this case, the first connection pipeline 127 and the second connection pipeline 128 are both blocked, and the mineralization pipeline 121, the inhibition pipeline 122, and the acceleration pipeline 123 are connected in parallel between the water inlet pipeline 109 and the water outlet pipeline 60 and are arranged in parallel. The water in the mineralization pipeline 121, the water in the inhibition pipeline 122, and the water in the acceleration pipeline 123 are discharged after being mixed in the water outlet pipeline 60.

For example, when the mineralization filter element 124 is in the soaked state, the first control valve 1291 can be controlled to be in the state of allowing water to flow through; the second control valve 1292 can be controlled to be in the state of not allowing water to flow through; and the third control valve 1293, the fourth control valve 1294, and the fifth control valve 1295 can be controlled to be closed. In this way, both the second connection pipeline 128 and the acceleration pipeline 123 are blocked. The inhibition filter element 125 and the mineralization filter element 124 are connected through the first connection pipeline 127. The water containing the inhibitory substance can flow through the first connection pipeline 127 to the mineralization filter element 124, thus allowing the water containing the inhibitory substance to enter and fill the mineralization filter element 124. The mineralization filter element 124 can be soaked in the water containing the inhibitory substance.

For example, in order to prevent an excessive mineral content caused by soaking of the mineralization filter element 124, the first control valve 1291 can be controlled to be in the state of allowing water to flow through; the second control valve 1292 can be controlled to be in the state of not allowing water to flow through; the third control valve 1293 and the fourth control valve 1294 can be controlled to be closed; and the fifth control valve 1295 can be controlled to be opened. In this case, the second connection pipeline 128 is blocked. The inhibition filter element 125 and the mineralization filter element 124 are connected through the first connection pipeline 127. The water containing the inhibitory substance can flow to the mineralization filter element 124 through the first connection pipeline 127, thereby inhibiting the release of minerals from the mineralization filter element 124 and preventing the mineral content of the water from exceeding a standard content. The acceleration pipeline 123 is unblocked, so that the water containing the accelerant can flow to the water outlet pipeline 60. The acceleration filter element 126 can include a filter material that releases minerals, thereby adding the new kind of mineral into the water. For example, the acceleration filter element 126 includes a periclase filter material described below. The periclase filter material is an alkaline filter material, and released (dissolved) periclase can adjust the pH value of water, to improve the taste of drinking water and maintain a healthy state of a human body.

For example, when the mineralization filter element 124 is the middle to late stage of its service life, the first control valve 1291 can be controlled to be in the state of not allowing water to flow through; the second control valve 1292 can be controlled to be in the state of allowing water to flow through; and the third control valve 1293, the fourth control valve 1294, and the fifth control valve 1295 can be controlled to be closed. In this case, both the first connection pipeline 127 and the inhibition pipeline 122 are blocked, and the acceleration filter element 126 and the mineralization filter element 124 are connected through the second connection pipeline 128. The water containing the accelerant can flow to the mineralization filter element 124 through the second connection pipeline 128, thereby accelerating the release of minerals from the mineralization filter element 124 and ensuring that the minerals in the water can meet a standard. Even if the mineralization filter element 124 is in the middle to late stage of its lifespan (the dissolution rate of minerals decreases), by using the acceleration filter element 126, the dissolution rate of the minerals in the mineralization filter element 124 is maintained within a set range, and the service life of the mineralization filter element 124 can be prolonged. Or, in an expected large flow rate, the first control valve 1291 can be controlled to be in the state of not allowing water to flow through; the second control valve 1292 can be controlled to be in the state of allowing water to flow through; and the third control valve 1293, the fourth control valve 1294, and the fifth control valve 1295 can be controlled to be closed, so that the minerals in the water can meet the standard at the large flow rate.

For example, in an expected large flow rate, when a new kind of mineral is added into the water, the first control valve 1291 can be controlled to be in the state of not allowing water to flow through; the second control valve 1292 can be controlled to be in the state of allowing water to flow through; the third control valve 1293 and the fifth control valve 1295 can be controlled to be closed; and the fourth control valve 1294 can be controlled to be opened. In this case, the first connection pipeline 127 is blocked. The promotion filter element 126 and the mineralization filter element 124 are connected through the second connection pipeline 128. The water containing the accelerant can flow to the mineralization filter element 124 through the second connection pipeline 128, thereby promoting the release of minerals from the mineralization filter element 124, to make the minerals in the water to meet the standard. The inhibition pipeline 122 is unblocked, so that the water containing the inhibitory substance can flow to the water outlet pipeline 60. The inhibition filter element 125 can include a filter material that releases minerals, thereby adding the new kind of mineral into the water. For example, the inhibition filter element 125 includes a zeolite filter material described below. Zeolite released (dissolved) by the zeolite filter material can adsorb harmful substances such as heavy metals, ammonium, and hydrogen compounds in water, which greatly improves the water quality. In addition, zeolite can further adjust the pH value of water, to improve the taste of drinking water and maintain a healthy state of a human body.

In an optional embodiment, the first control valve 1291, the second control valve 1292, the third control valve 1293, the fourth control valve 1294, and the fifth control valve 1295 are all electromagnetic valves. Of course, in other embodiments, the first control valve 1291, the second control valve 1292, the third control valve 1293, the fourth control valve 1294, and the fifth control valve 1295 can further use other valves.

In an optionally embodiment, the mineralization filter element 124 includes a metasilicic-acid-containing filter material; the inhibition filter element 125 includes a zeolite filter material; and the acceleration filter element 126 includes an alkaline filter material. In other embodiments, the mineralization filter element 124 can further include a filter material containing other minerals, such as copper, calcium, magnesium, potassium, strontium, and zinc. It should be noted that when the mineralization filter element 124 includes the filter material containing other minerals, a corresponding acceleration filter material is matched in the acceleration filter element 126, and a corresponding inhibition filter material is matched in the inhibition filter element 125.

In an optional embodiment, the mineralization filter element 124 includes maifanite; the acceleration filter element 126 includes periclase; and the inhibition filter element 125 includes zeolite.

By using the above filter element unit 203, the water containing the inhibitory substance is conveyed to the mineralization filter element 124, to inhibit the release of minerals from the mineralization filter element 124, thereby preventing an excessive mineral content of the water. Furthermore, the water containing the accelerant is conveyed to the mineralization filter element 124 to accelerate the release of minerals from the mineralization filter element 124, to prevent the phenomenon that the mineral content of the water does not meet the standard.

In some embodiments, the control module can also control the on/off of various control valves in the mineralization filter element unit 203 based on the pH value of the water, thereby ensuring that the pH value of the water filtered out by the mineralization filter element unit 203 remains within a preset pH threshold range.

Referring to FIG. 9, a schematic structural diagram of a mineralization water purifier 2 according to an embodiment of the present disclosure is shown. The mineralization water purifier 2 includes a mineralization waterway system 1.

For the mineralization waterway system 1, refer to FIG. 1 to FIG. 8 and their related descriptions.

It should be understood that the various variations and specific embodiments of the mineralization waterway system 1 provided in the above embodiments are also applicable to the mineralization water purifier 2 in this embodiment. Through the detailed description of the mineralization waterway system 1, those skilled in the art can clearly understand an implementation process of the mineralization water purifier 2 in this embodiment. For the sake of simplicity of the specification, it will not be described in detail here.

It can be understood that the mineralization waterway system according to the embodiments of the present disclosure includes hardware structures and/or software modules corresponding to the execution of various functions. The embodiments of the present disclosure can be implemented in the form of hardware or a combination of hardware and computer software in combination with units and algorithm steps of the various examples described in the embodiments of the present disclosure. Whether a function is implemented in hardware or in a manner of driving hardware by computer software depends on particular applications and design constraint conditions of the technical solutions. A person skilled in the art can use different methods to implement the described functions for each particular application, but it should not be considered that this implementation goes beyond the scope of the technical solutions of the embodiments of the present disclosure.

It can be understood that “plurality” in the embodiments of the present disclosure mean two or more, and other quantifiers are similar to it. The term “and/or” describes an association relationship of associated objects, representing that three relationships can exist. For example, A and/or B can represent three situations: A exists alone; A and B exist simultaneously; and B exists alone. The character “/” usually indicates an “or” relation between associated objects. The singular forms of “one” and “the” are also intended to include a plural form, unless the context clearly indicates other meanings.

It can be further understood that the terms “first”, “second”, and the like are used for describing various information, but the information should be not limited by these terms. These terms are only used to distinguish information of the same type from each other, and do not represent a particular order or importance. Actually, the terms “first”, “second”, and the like can be completely interchanged for use. For example, without departing from the scope of the embodiments of the present disclosure, first information can also be referred to as second information, and similarly, second information can also be referred to as first information.

Further, it can be understood that orientations or positional relationships indicated by the terms “center”, “longitudinal”, “transverse”, “front”, “rear”, “upper”, “lower”, “left”, “right”, “vertical”, “horizontal”, “top”, “bottom”, “inner”, “outer”, and the like are orientations or positional relationships as shown in the drawings, and are only for the purpose of facilitating and simplifying the descriptions of this embodiment instead of indicating or implying that devices or elements indicated must have particular orientations, and be constructed and operated in the particular orientations.

It can be further understood that, unless otherwise specified, “connection” includes direct connections between two entities without any other components between them, as well as indirect connections between two entities with other components between them.

It can be further understood that although the operations are described in a specific order in the accompanying drawings in the embodiments of the present disclosure, they should not be understood as requiring the execution of these operations in the specific order or serial order shown, or requiring the execution of all the operations shown to achieve the desired results. In a specific environment, multitasking and parallel processing can be advantageous.

Those skilled in the art will easily come up with other implementations of the embodiments of the present disclosure after considering this specification and implementing the invention disclosed here. The present disclosure aims to cover any variations, uses, or adaptive changes of the embodiments of the present disclosure, and these variations, uses, or adaptive changes follow the general principles of the embodiments of the present disclosure and include common knowledge or customary technical means in the technical field that are not disclosed in the embodiments of the present disclosure. This specification and the embodiments are considered as merely exemplary, and the real scope and spirit of the embodiments of the present disclosure are pointed out in the following claims.

It should be understood that the embodiments of the present disclosure are not limited to the precise structures that have been described above and shown in the drawings, and various modifications and changes can be made without departing from the scope of the present disclosure. The scope of the embodiments of the present disclosure is subject only to the appended claims.

What is claimed is:

1. A mineralization waterway system, comprising:
a water inlet pipeline;
a pre-filter element unit, a reverse osmosis (RO) filter element unit, a mineralization filter element unit, and a water pump;
wherein the pre-filter element unit, the water pump, a purified water side of the reverse osmosis filter element unit, and the mineralization filter element unit constitute a mineralization water circuit;
the water inlet pipeline is connected to the pre-filter element unit, the mineralization water circuit is connected to a water inlet side of the reverse osmosis filter element unit through the pre-filter element unit, to a purified water side of the reverse osmosis filter element unit through the mineralization filter element unit, and to a water inlet side of the pre-filter element unit through the mineralization filter element unit; the water pump is installed between a water outlet side of the pre-filter element unit and the water inlet side of the reverse osmosis filter element unit; and the mineralization water circuit is provided with a mineralization water circuit control valve.

2. The mineralization waterway system according to claim 1, wherein the mineralization water circuit comprises a first mineralization water branch and a second mineralization water branch, the first mineralization water branch is connected to the mineralization filter element unit, the second mineralization water branch is respectively connected to the first mineralization water branch, the mineralization filter element unit, the water inlet pipeline, and the pre-filter element unit.

3. The mineralization waterway system according to claim 2, wherein the first mineralization water branch is provided with a first one-way valve and a first switch valve, a water inlet side of the first one-way valve is connected to the mineralization filter element unit, a water outlet side of the first one-way valve is connected to a water inlet side of the first switching valve.

4. The mineralization waterway system according to claim 3, wherein the second mineralization water branch is provided with a second one-way valve and a second switch valve, a water inlet side of the second switching valve is connected to both the water inlet side of the first one-way valve in the first mineralization water branch and the mineralization filter element unit; a water inlet side of the second one-way valve is connected to a water outlet side of the second switching valve, and a water outlet side of the second one-way valve is connected to the pre-filter element unit.

5. The mineralization waterway system according to claim 4, the mineralization waterway system 1 further comprising: a first water quality testing instrument, wherein the first water quality testing instrument is configured to test a first water quality parameter of an upstream of the mineralization filter element unit.

6. The mineralization waterway system according to claim 5, the mineralization waterway system 1 further comprising: a second water quality testing instrument, wherein the second water quality testing instrument is configured to test a second water quality parameter of a downstream of the mineralization filter element unit.

7. The mineralization waterway system according to claim 6, wherein the first water quality testing instrument and the second water quality testing instrument both comprises a Total Dissolved Solids tester or a conductivity meter.

8. The mineralization waterway system according to claim 6, wherein a difference between the first water quality parameter and the second water quality parameter is configured to control on/off of the mineralization water circuit control valve.

9. The mineralization waterway system according to claim 8, wherein a flow control unit is installed at the water inlet pipeline, according to the difference between the first water quality parameter and the second water quality parameter, a flow rate of the flow control unit varies.

10. The mineralization waterway system according to claim 8, wherein the flow control unit comprises valves, flow meters, regulators.

11. The mineralization waterway system according to claim 1, wherein the mineralization filter element unit comprises a mineralization pipeline, and a mineralization filter element is arranged on the mineralization pipeline.

12. The mineralization waterway system according to claim 1, wherein the mineralization filter element unit comprises: a mineralization pipeline and an inhibition pipeline which are arranged in parallel and capable of simultaneously or separately discharging water; the mineralization pipeline is provided with a mineralization filter element; the inhibition pipeline is provided with an inhibition filter element; a serially-connected switching pipeline is arranged between the mineralization pipeline and the inhibition pipeline; the serially-connected switching pipeline is configured to connect the inhibition filter element to the mineralization filter element in series; an output side of the serially-connected switching pipeline is connected to the mineralization pipeline or the mineralization filter element; an input side of the serially-connected switching pipeline is connected to the inhibition pipeline or the inhibition filter element; and a control valve is arranged on the serially-connected switching pipeline.

13. The mineralization waterway system according to claim 12, wherein the mineralization filter element comprises a zinc-containing filter material; and the inhibition filter element comprises an alkaline filter material.

14. The mineralization waterway system according to claim 12, wherein the mineralization filter element comprises a first alkaline filter material; the inhibition filter element comprises a second alkaline filter material; and the second alkaline filter material is configured to inhibit dissolution of an alkaline substance from the first alkaline filter material.

15. The mineralization waterway system according to claim 1, wherein the mineralization filter element unit comprises: a mineralization pipeline and an acceleration pipeline which are arranged in parallel and capable of simultaneously or separately discharging water; the mineralization pipeline is provided with a mineralization filter element; the acceleration pipeline is provided with an acceleration filter element; a serially-connected switching pipeline is arranged between the mineralization pipeline and the acceleration pipeline; the serially-connected switching pipeline is configured to connect the acceleration filter element to the mineralization filter element in series; an output side of the serially-connected switching pipeline is connected to the mineralization pipeline or the mineralization filter element; an input side of the serially-connected switching pipeline is connected to the acceleration pipeline or the acceleration filter element; and a control valve is arranged on the serially-connected switching pipeline.

16. The mineralization waterway system according to claim 15, wherein the mineralization filter element comprises a metasilicic-acid-containing filter material, and the acceleration filter element comprises an alkaline filter material.

17. The mineralization waterway system according to claim 16, wherein the mineralization filter element comprises maifanite, and the acceleration filter element comprises periclase.

18. The mineralization waterway system according to claim 1, wherein the mineralization filter element unit comprises: a mineralization pipeline, an inhibition pipeline, and an acceleration pipeline which are arranged in parallel and capable of simultaneously or separately discharging water; the mineralization pipeline is provided with a mineralization filter element; the inhibition pipeline is provided with an inhibition filter element; the acceleration pipeline is provided with an acceleration filter element; a first connection pipeline is arranged between the mineralization pipeline and the inhibition pipeline; an output side of the first connection pipeline is connected to the mineralization pipeline or the mineralization filter element; an input side of the first connection pipeline is connected to the inhibition pipeline or the inhibition filter element; a first control valve is arranged at the first connection pipeline; a second connection pipeline is arranged between the mineralization pipeline and the acceleration pipeline; an output side of the second connection pipeline is connected to the mineralization pipeline or the mineralization filter element; an input side of the second connection pipeline is connected to the acceleration pipeline or the acceleration filter element; and a second control valve is arranged at the second connection pipeline.

19. The mineralization waterway system according to claim 18, wherein the mineralization filter element comprises a metasilicic-acid-containing filter material; the acceleration filter element comprises an alkaline filter material; and the inhibition filter element comprises a zeolite filter material.

20. A mineralization water purifier, comprising the mineralization waterway system according to claim 1.
